(19) United States
(12) Patent Application Publication
(10) Pub. No.: US 2024/0039758 A1
(43) Pub. Date: Feb. 1, 2024

(54) COMMUNICATION METHODS, ROUTE REFLECTOR, HOST AND COMPUTER SYSTEM FOR IMPLEMENTING SUCH METHODS

(71) Applicant: Orange, Issy-les-Moulineaux (FR)

(72) Inventor: Benoît Lemoine, Châtillon Cedex (FR)

(21) Appl. No.: 18/258,701

(22) PCT Filed: Dec. 10, 2021
(86) PCT No.: PCT/FR2021/052276

§ 371 Date: Jun. 21, 2023

(30) Foreign Application Priority Data
Dec. 23, 2020 (FR) FR2014053

(51) Int. Cl. H04L 12/46; H04L 45/745; H04L 45/50

(52) U.S. Cl. CPC H04L 12/4633; H04L 45/745; H04L 45/50

(57) ABSTRACT

A communication method is implemented by a route reflector belonging to a computer system including at least one server in which a virtual proxy and a host are connected. The method includes, for each host, storing an identifier of a private network of the source and destination hosts, receiving, from the proxy connected to that host, a notification including a hardware address and a hop IP address of the host, and verifying a match between the hop IP address and one or more other IP addresses. If the match verification is negative, the method includes storing the hop IP address. The method also includes receiving from the host, an announcement message comprising the routes accessible via the hop IP address, and storing the announced routes.

### PRIOR ART

The present invention belongs to the general field of telecommunications. It relates more particularly to communication methods implemented by entities belonging to a computer system implementing a virtual local area switching network, as well as the entities and the computer system in question. The invention finds a particularly advantageous, although in no way limiting, application in the context of a small or medium-sized data center, namely therefore substantially of a hundred machines at most.

The computer virtualization technology is now well known. In its general principle, it consists in creating and executing, on a virtualization platform (commonly called “host machine”), one or more virtual representations of a computer or of its different resources, such as an operating system, a server, a desktop, a storage system, a network, etc. These simulated resources are in all respects identical to their physical versions localized on the client side.

Such a virtualization platform can for example include a plurality of layers, including in particular:
a virtualization layer or hypervisor, and
a layer of one or more virtual machines, each virtual machine executing a single operating system instance, called guest operating system, and operating independently of the other virtual machines in the virtualization platform.
   The automated deployment of the virtual machines on the virtualization layer is ensured by a virtual machine manager.

It should be noted that the virtualization technology is not limited to the implementation of virtual machines but also relates, in a manner known per se, to the implementation of sets of pods.

Furthermore, the virtualization technology can be available in different types, such as server and network virtualization, which is now increasingly used. This is in particular the case for an ever-increasing proportion of companies seeking to concentrate their computer resources in data centers and thus optimize their virtual computing/processing capacities, also known as cloud computing.

Also, to support the development of the server and network virtualization technology, the telecommunication operators have changed their practices. More specifically, these operators had been used physical telecommunication equipment, based on specialized ASIC (Application Specific Integrated Circuit) processors, and physically connected to virtual private networks (VPN) by dedicated interfaces on IP/MPLS (IP for Internet Protocol and MPLS for Multi Protocol Label Switching) routers implementing these VPNs.

Henceforth, said operators achieve developments making it possible to implement telecommunication services based on virtual network functions (VNF), which correspond more precisely to software components deployed on virtual machines or on pods in a set of virtualized computer servers. These are for example elementary virtual network functions such as virtual Ethernet bridges (examples: Linux bridges, or virtual Ethernet switches such as Open vSwitch switches) or more elaborate virtual network functions such as mobile network gateways (examples: Packet Data Network Gateway for 4G mobile networks or User Plane Function for the 5G mobile networks).

To connect virtual Ethernet interfaces of VNFs defined on several VPNs of IP/MPLS networks on the same VLAN (Virtual Local Area Network) Ethernet switching network established through a data center, the solutions deployed to date have in common to be based on a computer architecture implementing, in each server of the data center, a router known under the name PE (Provider Edge) router, which makes it possible to connect one or more virtual machines also called CE (Customer Edge) hosts, to the VPNs in question.

Such computer architecture (PE/CE association in a server) is also useful to address an issue consisting in being able to find to which VPN a CE host advertizing routes (i.e. providing routing information) belongs. This is an issue considered important for the server and network virtualization since, on the ability to address it, depends ultimately the ability to determine which other CE hosts are connected to the VLAN Ethernet network of a data center, but able to be connected to other VPNs than the one to which the host advertizing routes belongs, the routing information in question should be relayed.

Also, to address this issue of routing information propagation, it is customary to let a CE host advertize its routes to a virtual router instantiated by a VPN on the PE router to which said CE host is attached. In other words, it is through the PE routers attached to the CE hosts that an appropriate propagation of the routing information takes place.

It should be noted that the exchanges of routing information between PE routers are made in a conventional manner by means of an IP/MPLS device known as RR (route reflector) and defined in document RFC 4456 published by the IETF in April 2006. More particularly, such a route reflector RR allows, in a manner known per se, PE routers to exchange with each other the routing information that have been communicated to them. These exchanges, via a route reflector RR, are based in particular on the MP (Multi Protocol) extension of the BGP protocol (Border Gateway Protocol).

However, the fact that the propagation of the routing information is dependent on the PE routers has disadvantages. Indeed, to transport in an isolated manner (i.e. in a VPN tunnel) the traffic coming from a source CE host to a destination CE host, the source PE router associated with said source CE host must identify the destination PE router associated with said destination CE host. To do so, a switching table associating the addresses of each remote CE host and of the remote PE router attached to the latter is implemented at the level of the source PE router. As a result of these considerations that the source PE router must update said switching table each time a remote host is identified. Such an implementation is complex, thus making it difficult to guarantee transfer flow rate performances as well as the guarantee of a fault-free operation. Furthermore, this complexity itself induces a significant implementation cost which turns out to be incompatible with the current tendency aiming at favoring the concentration of computer resources in data centers.

### DISCLOSURE OF THE INVENTION

The present invention aims to overcome all or part of the drawbacks of the prior art, in particular those set out above, by proposing a solution that makes it possible to determine to which VPN a CE host advertizing routes belongs, in a simpler and less expensive manner than the solutions of the state of the art, so as to be able to guarantee performances of transfer flow rate and of fault-free operation but also to facilitate the determination of CE hosts towards which routes thus advertised should be relayed.

To this end, and according to a first aspect, the invention relates to a communication method implemented by a route reflector belonging to a computer system implementing a virtual local area switching network to which said route reflector is connected, said computer system further including at least one server in which a multiprotocol label switching virtual proxy and a host are connected, said virtual proxy being connected to the local area network as well as attached to a virtual private communication network. Said method includes, for each host of a server, a set of steps of:
saving an identifier of said private network in association with a hardware address of the host,
receiving, from the proxy connected to said host, a notification including an IP address of the host, called “hop address”, associated with said hardware address,
if, before receipt of said notification, one or more other IP addresses have been saved in association with one or more hardware addresses of hosts by the route reflector, verifying a match between said hop address and said other IP address(es),
if the match verification is negative or if no other IP address has been saved by the route reflector before the receipt of said notification, saving said hop address in association with the hardware address of the host,
receiving, from the host, an advertisement message including the routes accessible via said hop address,
saving said advertised routes in association with the identifier of said private network, the hardware address of the host and said hop address.

Fundamentally, the first method according to the invention differs from the state of the art in that the PE router functions in computer servers are here replaced with proxy functions that do not play any particular role in the learning of the routes, but also especially in that the route reflector is directly connected to the hosts. It is therefore the route reflector that is responsible for saving the data that identify to which VPN a host belongs.

It should be noted that the invention finds a particularly advantageous, although in no way limiting, application in the context of a computer system implemented in a small or medium-sized data center, therefore namely substantially of one hundred machines at most, in such a way that Ethernet switches connecting the servers inside the computer system are able to process all the Ethernet addresses exposed on the virtual local area switching network.

In particular implementations, the communication method can further include one or more of the following characteristics, taken separately or in all technically possible combinations.

In particular implementations, the computer system includes a server in which a virtual proxy called “destination proxy”, and a host called “destination host” are connected, as well as a gateway connected to the local area network, said method further including, before the execution of said set of steps, steps of:
receiving, from said gateway, an advertisement message including an identifier called “tunnel identifier”, as well as the routes accessible, by means of said tunnel identifier and in the private network, via an IP address of said gateway,
saving said advertised routes in association with the identifier of said private network, said tunnel identifier and said IP address of the gateway,
   said set of steps associated with the destination host also including steps of:
transmitting the tunnel identifier to a virtualization management system belonging to the computer system,
transmitting to said gateway an advertisement message including the routes accessible, by means of said tunnel identifier and in the private network, via said hop address.

Such provisions make it possible, thanks to the addition of said gateway in the computer system, to connect the VPNs of a data center in which said computer system would be implemented to IP/MPLS VPNs external to said data center.

These provisions therefore also make it possible to implement incoming communications in said computer system via VPN tunnels established from the gateway to the destination host.

In particular implementations, the computer system includes a server in which a virtual proxy called “source proxy”, and a host called “source host” are connected, as well as a gateway connected to the local area network, said method further including, before the execution of said set of steps, steps of:
receiving, from said gateway, an advertisement message including an identifier called “tunnel identifier”, as well as the routes accessible, by means of said tunnel identifier and in the private network, via an IP address of said gateway,
saving said advertised routes in association with the identifier of said private network, said tunnel identifier and said IP address of the gateway,
   said set of steps associated with the source host also including steps of:
transmitting the tunnel identifier to a virtualization management system belonging to the computer system,
transmitting to the source host an advertisement message including the routes accessible, in the private network, via the IP address of the gateway.

These provisions here make it possible to implement outgoing communications from said computer system via VPN tunnels established from the source host to the gateway.

In particular implementations, the computer system includes a first server in which a virtual proxy called “source proxy” (PR-S) and a host called “source host” are connected, as well as a second server in which a virtual proxy called “destination proxy”, and a host called “destination host” are connected, said source and destination proxies being attached to the same virtual private communication network, said method including an execution of said set of steps for each of the hosts of said servers and, after said set of steps has been executed for the destination host, a step of transmitting to the source host an advertisement message including the routes accessible via the hop address of the destination host.

According to a second aspect, the invention relates to a communication method implemented by a host belonging to a computer system implementing a virtual local area switching network, said computer system further including a route reflector connected to said local area network, a server in which a multiprotocol label switching virtual proxy and said host are connected, said virtual proxy being connected to the local area network as well as attached to a virtual private communication network. Said method comprises steps of:
freely transmitting to the proxy a notification including a hardware address of the host as well as an IP address of the host called “hop address”, associated with said hardware address,
transmitting to the route reflector an advertisement message including the routes accessible via said hop address.

Said communication method implemented by a host inherits the same advantages as those mentioned above with reference to said communication method implemented by the route reflector.

It should be noted that the free transmission of a notification including a hardware address is made in accordance with an address resolution protocol “ARP” in the case of IPv4 addresses, or in accordance with an “ICMPv6” address resolution protocol (Internet Control Message Protocol version 6) in the case of IPv6 addresses, both of which are known to those skilled in the art, to offer the possibility to an IP host to send a notification to all the IP hosts on the VLAN local area switching network without having previously received an address resolution request.

In particular implementations, the communication method implemented by a host can also include one or more of the following characteristics, taken separately or in any technically possible combinations.

In particular implementations, the computer system includes a server in which a virtual proxy called “source proxy”, and a host called “source host” are connected, as well as a gateway connected to the local area network, said method being implemented by said source host and further including a step of receiving, from the route reflector, an advertisement message including the routes accessible, in the private network, via the IP address of the gateway.

In particular implementations, the computer system includes a first server in which a virtual proxy called “source proxy”, and a host called “source host” are connected, as well as a second server in which a virtual proxy called “destination proxy”, and a host called “destination host” are connected, said source and destination proxies being attached to the same virtual private communication network, said method being implemented by said source host and including a step of receiving, from the route reflector, an advertisement message including the routes accessible via the hop address of the destination host.

According to a third aspect, the invention relates to a computer program including instructions for the implementation of a communication method implemented by a route reflector according to the invention or a communication method implemented by a host according to the invention when said computer program is executed by a computer.

This program can use any programming language, and be in the form of source code, object code or intermediate code between source code and object code, such as in partially compiled form, or in any other desirable form.

According to a fourth aspect, the invention relates to a computer-readable information or recording medium on which a computer program according to the invention is recorded.

The information or recording medium can be any entity or device capable of storing the program. For example, the medium can include a storage means, such as a ROM, for example a CD ROM or a microelectronic circuit ROM, or a magnetic recording means, for example a floppy disk or a hard disk.

On the other hand, the information or recording medium can be a transmissible medium such as an electrical or optical signal, which can be conveyed via an electrical or optical cable, by radio or by other means. The program according to the invention can be particularly downloaded from an Internet-type network.

Alternatively, the information or recording medium can be an integrated circuit in which the program is incorporated, the circuit being adapted to execute or to be used in the execution of the method in question.

According to a fifth aspect, the invention relates to a route reflector including means configured to implement a communication method according to the invention.

According to a sixth aspect, the invention relates to a host including means configured to implement a communication method according to the invention.

According to a seventh aspect, the invention relates to a system including a route reflector according to the invention and at least one server in which a multiprotocol label switching virtual proxy and a host are connected according to the invention.

### BRIEF DESCRIPTION OF THE DRAWINGS

Other characteristics and advantages of the present invention will become apparent from the description given below, with reference to the appended drawings which illustrate an exemplary embodiment without any limitation. On the pictures:

FIG. 1 schematically represents, in its environment, a particular implementation of a computer system according to the invention;

FIG. 2 schematically represents an example of hardware architecture of a road reflector according to the invention belonging to the computer system of FIG. 1;

FIG. 3 schematically represents an example of hardware architecture of a host according to the invention, called “source host”, belonging to the computer system of FIG. 1;

FIG. 4 schematically represents an example of hardware architecture of a host according to the invention, called “destination host”, belonging to the computer system of FIG. 1;

FIG. 5 represents, in the form of a flowchart, a particular implementation of a communication method, called “general method”, implemented by the computer system of FIG. 1, said general method encompassing first, second and third methods according to the invention and respectively implemented by the route reflector, source host and destination host of FIGS. 2, 3 and 4;

FIG. 6 schematically represents an Ethernet frame transmitted between the source host of FIG. 3 and the destination host of FIG. 4 when implementing the general method of FIG. 5;

FIG. 7 schematically represents, in its environment, another particular embodiment of a computer system according to the invention;

FIG. 8 represents, in the form of a flowchart, one particular implementation, called “incoming communication implementation”, of the general method implemented by the computer system SI_BIS of FIG. 7;

FIG. 9 schematically represents an Ethernet frame transmitted by a network gateway to the destination host of FIG. 4 when implementing the method of FIG. 8;

FIG. 10 represents, in the form of a flowchart, one particular implementation, called “outgoing communication implementation”, of the general method implemented by the computer system SI_BIS of FIG. 7;

FIG. 11 schematically represents an Ethernet frame transmitted by the source host of FIG. 3 to a network gateway when implementing the method of FIG. 10.

### DESCRIPTION OF THE EMBODIMENTS

FIG. 1 schematically represents, in its environment, a particular implementation of a computer system SI according to the invention.

In the embodiment of FIG. 1, the computer system SI is arranged in a data center DC and implements an Ethernet switching network corresponding to a VLAN virtual local area switching network. Such a VLAN virtual network corresponds, in a manner known per se and with reference to the nomenclature of the OSI (Open Systems Interconnection) model, to a level network 2 making it possible to segment the traffic exchanged on this network according to hardware addresses, called “MAC” (Media Access Control) addresses, of devices owned by users.

The computer system SI is configured to implement a virtualization of servers interconnected via the VLAN virtual network. To this end, and as illustrated in the embodiment of FIG. 1, the computer system SI includes a virtualization management system SGV which comprises, in a manner known per se:
a management device of the local area network called a “VNM” (Virtual Network Manager) device. It is an entity configured to manage the creation of virtual interfaces on virtual switching elements (software in the operating system, or hardware in the network interface cards) of computer servers;
a virtual infrastructure management device called “VIM” (Virtual Infrastructure Manager) device. It is an entity configured to manage the creation of virtual machines or sets of pods in a computer server.

In the present embodiment, the computer system SI also includes two computer servers, namely:
a first server SERV-1 in which a multiprotocol label switching virtual proxy called “source proxy” PR-S, and a host called “source host” CE-S are connected. Said source proxy PR-S is a proxy using the MPLS (Multi Protocol Label Switching) transport mechanism;
a second server SERV-2 in which a virtual proxy MPLS called “destination proxy” PR-D, and a host called “destination host” CE-D are connected. Said destination proxy PR-D is a proxy also using the MPLS transport mechanism.

Said source PR-S and destination PR-D proxies are further connected to the VLAN local area network.

It should be noted that the denominations “source” and “destination” refer here to roles respectively played by the proxies/hosts in the context of communications established via the transmission of Ethernet frames, both within a Private VPN network to which they belong or to other IP/MPLS VPN networks located outside of the data center DC. These aspects are explained in more detail later on in the description of different communication methods according to the invention.

Although it is considered in the embodiment of FIG. 1 that the computer system SI includes only two servers, only one including a proxy/source host and only one including a proxy/destination host), it important to note that this is only a variant of implementation of the invention. The fact remains that other variants of implementation can be envisaged, such as for example a single server including a proxy/source host and a plurality of servers each including a proxy/destination host, or a plurality of servers each including a proxy/source host and a single server including a proxy/destination host, or a plurality of servers each including a proxy/source host and a plurality of servers each including a proxy/destination host.

In general, no limitation is attached to the number of servers each including a proxy/source host and to the number of servers each including a proxy/destination host. Of course, no limitation is either attached to the number of hosts that can be integrated into a server. For example, a server can host several source hosts or several destination hosts, or a source host and a destination host, or one or more source hosts and one or more destination hosts.

Finally, no limitation is attached to the number of virtual private networks VPNs to which the proxies can be connected. For example, a server can host several source hosts for which a proxy will have to save a different identifier for their virtual Ethernet interfaces (it is an identifier called “tunnel identifier” as described in more detail later).

Conventionally, each host contained in a server is associated with a hardware MAC address as well as an IP address. How a hardware MAC address can be assigned to a host is detailed later.

Each virtual private network is also associated with an identifier making it possible to differentiate it from other virtual private networks.

For the remainder of the description, the notations according to which the MAC addresses of the source CE-S and destination CE-D hosts are respectively referenced CE-S MAC@ and CE-D MAC@ are adopted. It is also considered that the source host CE-S (respectively the destination host CE-D) is associated with an IP address referenced CE-S NH@ (respectively referenced CE-D NH@) and associated with said hardware address CE-S MAC@ (respectively associated with said hardware address CE-D MAC@). Finally, it is also considered that the source PR-S and destination PR-D proxies are attached to the same given VPN virtual private communication network, whose identifier is denoted VPN-ID, so as to allow the source CE-S and destination CE-D hosts to communicate with each other.

It is noted that the denomination “hop address” is also used subsequently for the IP addresses CE-S NH@ and CE-D NH@. This denomination is used to mean that this is an address to be used as the next hop to reach the host with which such an IP address is associated.

In the present embodiment, and as illustrated in FIG. 1, the computer system SI also includes a route reflector RR connected to the VLAN local area network. In accordance with the invention, the route reflector RR is configured to perform processing operations making it possible to save and advertize routes accessible via said hop addresses CE-S NH@ and CE-D NH@, by implementing a communication method, called “first method”, according to the invention.

The source host CE-S, for its part, is configured to perform processing operations making it possible to advertize the routes accessible via its hop address CE-S NH@ so as to be able to establish a communication with the destination host CE-D, by implementing a communication method, called “second method”, according to the invention.

Similarly, the destination host CE-D is configured to perform processing operations making it possible to advertize the routes accessible via its hop address CE-D NH@ so as to be able to establish a communication with the source host CE-S, by implementing a communication method, called “third method”, according to the invention.

FIG. 2 schematically represents an example of hardware architecture of the route reflector RR belonging to the computer system SI of FIG. 1, for the implementation of the first method according to the invention.

As illustrated in FIG. 2, the route reflector RR has the hardware architecture of a computer. Thus, the route reflector RR includes, in particular, a processor 1-RR, a random access memory 2-RR, a read only memory 3-RR and a non-volatile memory 4-RR. It further includes a communication module 5-RR.

The read only memory 3-RR of the route reflector RR constitutes a recording medium in accordance with the invention, readable by the processor 1-RR and on which a computer program PROG-RR in accordance with the invention is recorded, including instructions for the execution of steps of the first method. The program PROG-RR defines functional modules (in this case, these are software modules) of the route reflector RR, which are based on or control the hardware elements 1-RR to 5-RR of the source proxy PR-S mentioned above, and which comprise in particular:
a first saving module MOD_MEM1-RR configured to save the identifier VPN-ID of the private VPN network in association with the hardware address CE-S MAC@, CE-D MAC@ of a host CE-S, CE-D,
a first receiving module MOD_RX1-RR configured to receive, from a proxy PR-S, PR-D connected to a host CE-S, CE-D, a notification including the hop address CE-S NH@, CE-D NH@ of said host associated with the hardware address CE-S MAC@, CE-D MAC@ thereof,
a first verification module MOD_VERIF1-RR configured to verify whether one or more other IP addresses have been saved in association with one or more host hardware addresses (said hardware address(es) is/are for example associated with other possible hosts which can be either source or destination hosts) by the route reflector RR before the receipt of said notification,
a second verification module MOD_VERIF2-RR configured to verify, if the verification of the first verification module MOD_VERIF1-RR is positive, a match between the received hop address and said other IP address(es),
a second saving module MOD_MEM2-RR configured to save, if the verification of the second verification module MOD_VERIF2-RR is negative or if no other IP address has been saved by the route reflector RR before the receipt of said notification, said hop address received in association with the hardware address of the host,
a second receiving module MOD_RX2-RR configured to receive, from a host CE-S, CE-D, an advertisement message including the routes accessible via the hop address CE-S NH@, CE-D NH@ associated with said host,
a third saving module MOD_MEM3-RR configured to save the routes advertised by a host CE-S, CE-D in association with the identifier VPN-ID of said private VPN network, the hardware address CE-S MAC@, CE-D MAC@ of the host and the hop address CE-S NH@, CE-D NH@ associated with said host,
a transmission module MOD_TX-RR configured to transmit to the source host CE-S an advertisement message including the routes accessible via the hop address CE-D NH@ of the destination host CE-D.

The communication module 5-RR allows the route reflector RR to communicate with other entities of the computer system SI, in particular the source CE-S and destination CE-D hosts, the source PR-S and destination PR-D proxies, as well as the VNM device. It can comprise for example a virtual network card or any other means making it possible to connect to the VLAN local area network. Said communication module 5-RR in particular integrates said first and second receiving modules MOD_RX1-RR, MOD_RX2-RR as well as the transmission module MOD_TX-RR.

It is moreover noted that the data saved thanks to the different saving modules MOD_MEM1-RR, MOD_MEM2-RR, MOD_MEM3-RR are stored, in the present embodiment, in the non-volatile memory 4-RR equipping the route reflector RR.

FIG. 3 schematically represents an example of hardware architecture of the source host CE-S belonging to the computer system SI of FIG. 1, for the implementation of the second method according to the invention.

As illustrated in FIG. 3, the source host CE-S has the hardware architecture of a computer. Thus, the source host CE-S includes, in particular, a processor 1-S, a random access memory 2-S, a read only memory 3-S and a non-volatile memory 4-S. It further includes a communication module 5-S.

The read only memory 3-S of the source host CE-S constitutes a recording medium in accordance with the invention, readable by the processor 1-S and on which a computer program PROG-S in accordance with the invention is recorded, including instructions for the execution of steps of the second method. The program PROG-S defines functional modules (in this case, these are software modules) of the source host CE-S, which are based on or control the hardware elements 1-S to 5-S of the source host CE-S cited above, and which comprise in particular:
a first transmission module MOD_TX1-S configured to freely transmit to the source proxy PR-S a notification including the hardware address CE-S MAC@ as well as the hop address CE-S NH@,
a second transmission module MOD_TX2-S configured to transmit to the route reflector RR an advertisement message including the routes accessible via said hop address CE-S NH@,
a receiving module MOD_RX-S configured to receive, from the route reflector RR, an advertisement message including the routes accessible via the hop address CE-D NH@ of the destination host CE-D.

The communication module 5-S allows the source host CE-S to communicate with other entities of the computer system SI, in particular the source proxy PR-S, the device VIM and the route reflector RR. It can comprise for example a virtual network card or any other means making it possible to connect to the VLAN local area network. Said communication module 5-S in particular integrates said first and second transmission modules MOD_TX1-S, MOD_TX2-S, as well as the receiving module MOD_RX-S.

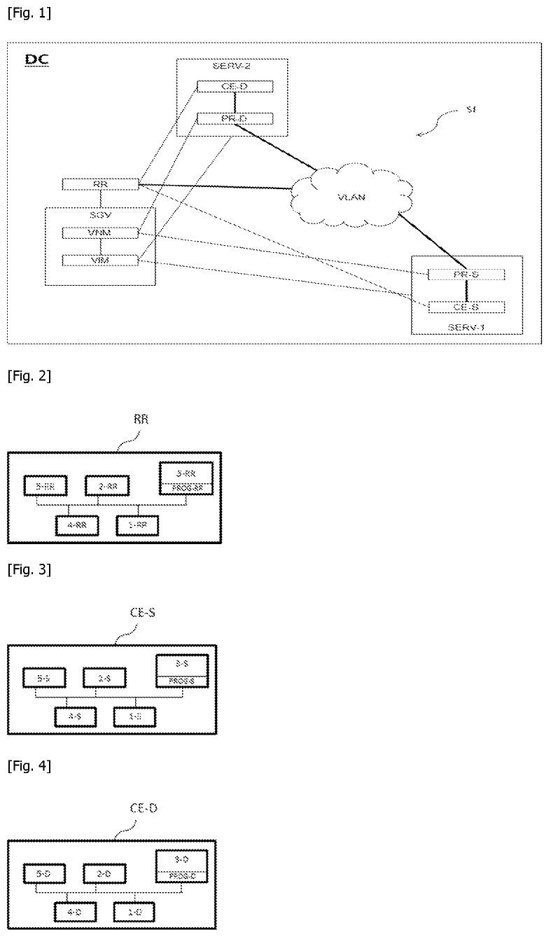

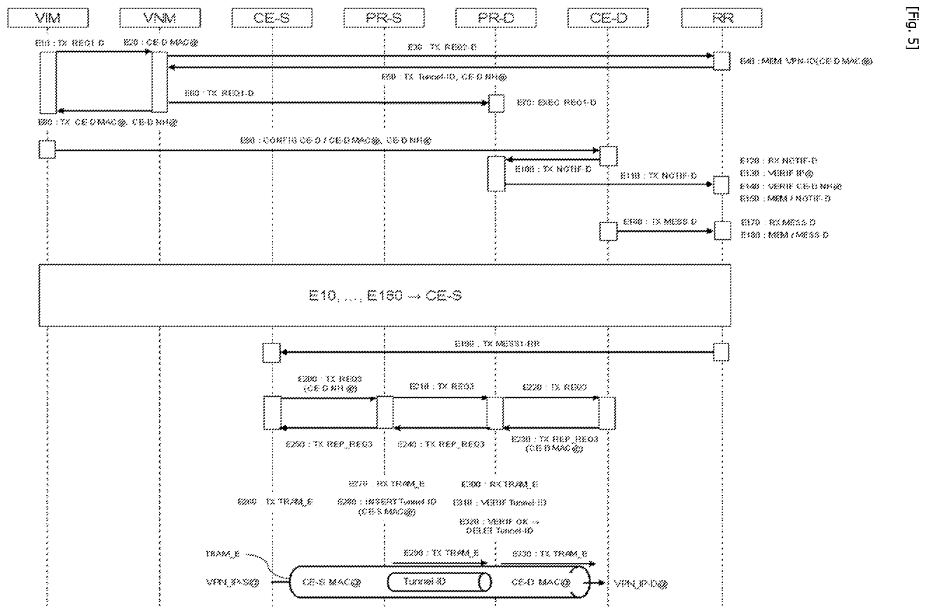

FIG. 4 schematically represents an example of hardware architecture of the destination host CE-D belonging to the computer system SI of FIG. 1, for the implementation of the third method according to the invention.

As illustrated in FIG. 4, the destination host CE-D has the hardware architecture of a computer. Thus, the destination host CE-D includes, in particular, a processor 1-D, a random access memory 2-D, a read only memory 3-D and a non-volatile memory 4-D. It further includes a communication module 5-D.

The read only memory 3-D of the destination host CE-D constitutes a recording medium in accordance with the invention, readable by the processor 1-D and on which a computer program PROG-D in accordance with the invention is recorded, including instructions for the execution of steps of the third method. The program PROG-D defines functional modules (in this case, these are software modules) of the destination host CE-D, which are based on or control the hardware elements 1-D to 5-D of the destination host CE-D mentioned above, and which comprise in particular:
a first transmission module MOD_TX1-D configured to freely transmit to the source proxy PR-D a notification including the hardware address CE-D MAC@ as well as the hop address CE-D NH@,
a second transmission module MOD_TX2-D configured to transmit to the route reflector RR an advertisement message including the routes accessible via said hop address CE-D NH@.

The communication module 5-D allows the destination host CE-D to communicate with other entities of the computer system SI, in particular the destination proxy PR-D, the device VIM and the route reflector RR. It can comprise for example a virtual network card or any other means making it possible to connect to the VLAN local area network. Said communication module 5-D in particular integrates said first and second transmission modules MOD_TX1-D, MOD_TX2-D.

FIG. 5 represents, in the form of a flowchart, a particular implementation of a communication method, called “general method”, implemented by the computer system SI. Said general method encompasses said first, second and third methods according to the invention respectively implemented by the route reflector RR of FIG. 2, the source host CE-S of FIG. 3 and the destination host CE-D of FIG. 4.

To this end, it should be noted that the modules described above for the route reflector RR, the source host CE-S and the destination host CE-D correspond to the main modules equipping these entities for the implementation of said first, second and third methods. The fact remains that each of these entities can still be equipped with other modules not specifically identified below, as will appear obvious to those skilled in the art.

Said general method includes a plurality of steps, including particularly a set of steps executed for each of the hosts of the first and second servers SERV-1, SERV-2. Also, and initially, said set of steps for the destination host CE-D is described.

As illustrated in FIG. 5, said general method initially includes a step E10 of issuing a request REQ1-D by the device VIM. Said request REQ1-D is established so as to configure, on the private VPN network and at the level of the destination proxy PR-D, a virtual interface for the destination host CE-D.

Upon receipt of the request REQ1-D, the VNM device chooses a hardware MAC address for the destination host CE-D during a step E20 of said general method. In the present implementation, said hardware MAC address is written CE-D MAC@, in accordance with the notations introduced previously.

Once the address CE-D MAC@ has been chosen, said general method includes a step E30 of transmitting a request REQ2-D, from the VNM device to the route reflector RR. Said request REQ2-D is a request established to obtain an identifier, called “tunnel identifier”, associated with the identifier VPN-ID of the private VPN network, the objective being, as described below, to associate the tunnel identifier thus obtained at the hardware address CE-D MAC@.

On receipt of the request REQ2-D, the route reflector RR saves the identifier VPN-ID of the private VPN network in association with the hardware address CE-D MAC@ during a step E40 of the general method. More particularly, said step E40 is implemented by the first saving module MOD_MEM1-RR equipping the route reflector RR and forms an integral part, in the present implementation, of said first method.

Then, said route reflector RR transmits a tunnel identifier noted “Tunnel-ID” to the VNM device during a step E50 of the general method.

Said tunnel identifier Tunnel-ID corresponds, in the present embodiment, to an MPLS label and can be determined in different ways. For example, such a tunnel identifier Tunnel-ID may have been configured beforehand manually at the level of the route reflector RR so that the latter is aware of it. According to another example, said tunnel identifier Tunnel-ID can be generated randomly by the route reflector RR.

In the implementation illustrated by FIG. 5, the transmission of the tunnel identifier Tunnel-ID (step 50) is accompanied by a transmission of an IP address for said destination host CE-D. Said IP address is written CE-D NH@, in accordance with the notations introduced previously, and corresponds to a hop address associated with the destination host CE-D. The hop address CE-D NH@ thus transmitted corresponds to an IP address that the route reflector RR proposes, on its own initiative, for said destination host CE-D. It should however be noted that the fact of making such a proposal corresponds to an optional implementation of the general method, aiming to avoid collisions of addresses. However, nothing excludes envisaging that the route reflector RR does not make such an IP address proposal, and that it is the VNM device that handles it alone. Moreover, nothing to exclude envisaging that the route reflector RR proposes an IP address to the VNM device, but that the latter does not take it into account and chooses an IP address on its own initiative. Ultimately, no limitation is attached on how the hop address CE-D NH@ is assigned to the destination host CE-D for the Private VPN network.

It should be noted that the saving step E40 is here described as being triggered by the receipt of the request REQ2-D. However, nothing excludes envisaging that the route reflector RR saves the identifier VPN-ID of the private VPN network in association with the hardware address CE-D MAC@ following the receipt of a message other than said request REQ2-D, such as for example an information message transmitted by the VNM device to inform the route reflector RR of the data intended to be saved.

Furthermore, nothing excludes envisaging that the route reflector RR transmits to the VNM device the tunnel identifier Tunnel-ID on its own initiative that is to say without a request such as said request REQ2-D being issued.

To process the request REQ1-D, and once the address CE-D MAC@ and the tunnel identifier Tunnel-ID are in possession of the VNM device, said general method includes a step E60 of transmitting the request REQ1-D, from the VNM device to the destination proxy PR-D. It is noted that said request REQ1-D now includes a request to associate, at the level of the destination proxy PR-D, the hardware address CE-D MAC@ with the tunnel identifier Tunnel-ID itself already associated with the identifier VPN-ID.

Following the transmission of said request REQ1-D to the destination proxy PR-D, the general method includes a step E70 of executing the request REQ1-D by the destination proxy PR-D, so that a virtual interface is configured for the destination host CE-D at the level of the destination proxy PR-D.

The hardware address CE-D MAC@ and hop address CE-D NH@ are further transmitted from the VNM device to the VIM device. This is the subject of a step E80 of the general method, as illustrated in FIG. 5. Therefore, the VIM device is able to configure the destination host CE-D with the addresses CE-D MAC@ and CE-D NH@ (i.e. to assign to the destination host CE-D the addresses CE-D MAC@ and CE-D NH@) that the VNM device has communicated to it, which is the subject of a step E90 of the general method.

In the implementation illustrated by FIG. 5, the general method also includes a step E100 of freely transmitting, from the destination host CE-D to the destination proxy PR-D, a notification NOTIF-D including the hardware address CE-D MAC@ as well as the hop address CE-D NH@. More particularly, said step E100 is implemented by the first transmission module MOD_TX1-D Equipping the destination host CE-D and forms an integral part of the third method.

It should be noted that the free transmission of a notification including a hardware address depends on the version of the IP address to which it corresponds. In the case of an IPv4 address, the host sends an ARP message identical to the one provided for a response to a request, but without having received a request. Therefore, it sends this message not to the MAC address of a host that has emitted a request, but to the broadcast MAC address, so that all the hosts on the VLAN local area network can receive it. In the case of an IPv6 address, the host sends a “UNA” (Unsolicited Neighbor Advertisement) ICMPv6 message described in the RFC 4861 standard of the IETF, to the “ANMA” (All-Nodes Multicast Address) IPv6 address which allows it to be easily recognized by the routers so that the message is not transmitted as an IP packet outside the VLAN local area switching network, as well as to an associated multicast MAC address, which allows it to be transmitted to all the hosts on the VLAN local area switching network.

Upon receipt of the notification NOTIF-D, the destination proxy PR-D transmits said notification NOTIF-D to the route reflector RR during a step E110 of the general method.

The notification NOTIF-D is then received by the route reflector RR during a step E120 of the general method. More particularly, said step E120 is implemented by the first receiving module MOD_RX1-RR equipping the route reflector RR and forms an integral part, in the present implementation, of said first method.

Upon receipt of said notification NOTIF-D, the route reflector RR verifies during a step E130 of the general method whether it has saved, before receipt of said notification NOTIF-ID, one or more other IP addresses in association with one or more host hardware addresses. More particularly, said step E130 is implemented by the first verification module MOD_VERIF1-RR equipping the route reflector RR and forms an integral part, in the present implementation, of said first method.

Therefore, in the event that the route reflector RR had actually stored in memory one or more other IP addresses for one or more hosts before the receipt of the notification NOTIF-D, the route reflector RR performs, during in a step E140 of the general method, a match verification between the hop address CE-D NH@ and said other IP address(es) already saved. More particularly, said step E140 is implemented by the second verification module MOD_VERIF2-RR equipping the route reflector RR and forms an integral part, in the present implementation, of said first method.

If the match verification that is the subject of step E140 is negative, the route reflector RR saves, during a step E150 of the general method, said hop address CE-D NH@ in association with the hardware address CE-D MAC@ of the destination host CE-D. More particularly, said step E150 is implemented by the second saving module MOD_MEM2-RR equipping the route reflector RR and forms an integral part, in the present implementation, of said first method.

It should be noted that said step E150 is also implemented in the case where no other IP address has been saved in association with the hardware address CE-D MAC@ of said destination host CE-D by the route reflector RR before the receipt of said notification NOTIF-D. In other words, if the verification that is the subject of step E130 returns a negative result, step E150 is directly implemented (i.e. no step E140 is implemented).

In the implementation illustrated by FIG. 5, the general method also includes a step E160 of transmitting, from the host destination CE-D to the route reflector RR, an advertisement message MESS-D including the routes accessible via said hop address CE-D NH@. More particularly, said step E160 is implemented by the second transmission module MOD_TX2-D equipping the host destination CE-D and forms an integral part, in the present implementation, of said third method.

The advertisement message MESS-D is then received by the route reflector RR from the host destination CE-D during a step E170 of the general method. More particularly, said step E170 is implemented by the second receiving module MOD_RX2-RR equipping the route reflector RR and forms an integral part, in the present implementation, of said first method.

Upon receipt of said advertisement message MESS-D, the route reflector RR saves, during a step E180 of the general method, the routes thus advertised (i.e. the routes contained in the advertisement message MESS-D) in association with the identifier VPN-ID of said private VPN network, the hardware address CE-D MAC@ of the destination host CE-D and said hop address CE-D NH@. More particularly, said step E180 is implemented by the third saving module MOD_MEM3-RR equipping the route reflector RR and forms an integral part, in the present implementation, of said first method.

Steps E10 to E180 form the steps of the previously mentioned set of steps. Furthermore, and as also mentioned before, said set of steps E10 to E180 is executed for each of the hosts of the servers SERV-1, SERV-2, therefore also particularly for the source host CE-S. For the sake of simplifying the description, said steps E10 to E180 are not again described here in detail for the case of the source host CE-S. It is specified, at the very least, and as represented in FIG. 5, that the reference signs REQ1-D, REQ2-D, NOTIF-D, MESS-D are respectively renamed REQ1-S, REQ2-S, NOTIF-S, MESS-S for this iteration of the set of steps E10 to E180.

It is further understood that when steps E10 to E180 are iterated for the source host CE-S, the steps E100 and E160 form an integral part of the second method implemented by said source host CE-S.

Furthermore, it should be noted that the tunnel identifier Tunnel-ID transmitted by the route reflector RR to the VNM device (step E50) when the set of steps E10 to E180 is executed for the destination host CE-D is identical to the one transmitted to the VNM device when the set of steps E10 to E180 is executed for the source host CE-S. This is due to the fact that said first and second servers SERV-1, SERV-2 are attached to the same private VPN network. Ultimately, the virtual interfaces associated with the destination CE-D and source CE-S hosts at the level of the destination PR-D and source PR-D proxy are configured with the same tunnel identifier Tunnel-ID.

It is important to note that the set of steps E10 to E180 has been executed, in the present implementation, for the destination host CE-D initially, then for the source host CE-S. However, this is only a purely arbitrary implementation choice, and the mentioned order can of course be reversed.

The implementation of the general method does not stop at step E180. Thus, and as illustrated by FIG. 5, the general method also includes a step E190 of transmitting, from the route reflector RR to the source host CE-S, an advertisement message MESS1-RR including the routes accessible via the hop address CE-D NH@ of the destination host CE-D. More particularly, said step E190 is implemented by the transmission module MOD_TX-RR equipping the route reflector RR and forms an integral part, in the present implementation, of said first method.

Once said advertisement message MESS1-RR has been received by the source host CE-S, the general method includes optional steps allowing the effective implementation of a communication between the source CE-S and destination CE-D hosts. More particularly, said general method includes a step E200 of transmitting, from the source host CE-S to the source proxy PR-S, a request REQ3. Said request REQ3 is an address resolution request for the hop address CE-D NH@.

It should be noted that the request is issued in accordance with an address resolution protocol “ARP” in the case of IPv4 addresses, or in accordance with an “ICMPv6” (Internet Control Message Protocol version 6) address resolution protocol in the case of IPv6 addresses, both known to those skilled in the art as hardware address resolution protocols that can be used within a VLAN virtual local area switching network.

Also, upon receipt of the request REQ3, the source proxy PR-S transmits said request REQ3 to the destination proxy PR-D during a step E210 of the general method.

Upon receipt of the request REQ3, the destination proxy PR-D transmits said request REQ3 to the destination host CE-D during a step E220 of the general method.

Upon receipt of the request REQ3, the destination host CE-D responds to said request REQ3 by transmitting, during a step E230 of the general method, a response REP_REQ3 to the destination proxy PR-D, said response including the hardware address CE-D MAC@.

Upon receipt of said response REP_REQ3, the destination proxy PR-D transmits said response REP_REQ3 to the source proxy PR-S during a step E240 of the general method.

Upon receipt of said response REP_REQ3, the source proxy PR-S transmits said response REP_REQ3 to the source host CE-S during a step E250 of the general method.

It should be noted that the general method is described here in an implementation for which the computer system SI only includes one destination proxy (in this case, it is the destination proxy PR-D of FIGS. 1 and 4). It can nevertheless be noted that if said computer system SI includes a plurality of destination proxies, the request REQ3 issued by the source host CE-S (step E200) and received by the source proxy PR-S is transmitted by the latter to the set of said destination proxies. Of course, insofar as this request REQ3 concerns an address resolution for the IP address CE-D NH@, only the destination host CE-D responds thereto.

Furthermore, in the implementation illustrated by FIG. 5, the general method also includes a step E260 of emitting, by the source host CE-S and to the destination host CE-D, an IP packet within an Ethernet frame TRAM_E. Thus, said Ethernet frame TRAM_E encapsulates said IP packet emitted by the source host CE-S, and here includes the hardware addresses CE-S MAC@ and CE-D MAC@ which therefore respectively form source and destination addresses of the frame TRAM_E.

The source IP address attached to this IP packet is denoted VPN_IP-S@ in FIG. 5.

The general method then includes a step E270 of receiving, from the source host CE-S, the frame TRAM_E by the source proxy PR-S.

Upon receipt of the frame TRAM_E, the source proxy PR-S inserts into said frame TRAM_E, and during a step E280 of the general method, the tunnel identifier Tunnel-ID between the hardware addresses CE-S MAC@, CE-D MAC@ and the IP packet.

The insertion of the identifier Tunnel-ID in the frame TRAM_E is symbolized in FIG. 5 by the fact that said identifier Tunnel-ID defines an MPLS tunnel placed inside the frame TRAM_E. The source proxy PR-S thus forms a termination point of said MPLS tunnel, which is also the case for the destination proxy PR-D as described below.

It should be noted that if the IP packet encapsulated in the frame TRAM_E conforms to an IPv6 packet, it can be verified, before inserting the tunnel identifier Tunnel-ID and following a particular example of implementation, that said IP packet does not include an ICMPv6 address resolution message (request or response).

The choice consisting in performing such a verification however constitutes only one variant of implementation of step E150, and it is of course possible to envisage still other variants.

Indeed, unlike the IP packets, which are intended to be transferred by a router from one VLAN to another VLAN, the hardware address resolution messages can only be exchanged inside a VLAN switching local area network. Also, for next hop IP addresses of the IPv4 type (version 4 of the IP protocol), the messages of the ARP protocol are encapsulated directly on Ethernet and therefore cannot leave a VLAN. On the other hand, for the next hop IP addresses of the IPv6 type (version 6 of the IP protocol), the messages of the ICMPv6 protocol are encapsulated in IP on Ethernet and use specific IPv6 addresses, such as the “LLA” (Link-Local Address) or SNMA (Solicited-Node Multicast Address) whose format defined in the RFC 4861 standard of the IETF allows them to be easily recognized by the routers to avoid processing them as IP packets. Furthermore, the IPv6-type IP packets use different IPv6 addresses, called GUA (Global Unicast Address) whose standard format, different from the LLA or SNMA addresses, allows them to be easily recognized by the routers to authorize their transfer to other VLANs than the one on which they were received.

In other words, it is possible, following another exemplary implementation and based on the aforementioned considerations, to determine whether an IPv6 packet includes or not an address resolution message by performing this time a verification on the destination address used (LLA and SNMA, or GUA).

By way of illustration, an example of verification based on the type of destination addresses can consist in verifying:
whether the address is of the LLA or SNMA type, in which case it is an address resolution message, and a tunnel identifier should not be inserted; or
whether the address is of the GUA type, in which case it is an IP packet, and a tunnel identifier should be inserted.

Another example of verification based on the protocol number contained in the IP header can consist in verifying:
whether the protocol number is the standard number assigned to the ICMPv6 protocol, in which case it is an address resolution message, and a tunnel identifier should not be inserted; or
whether the protocol number is not the standard number assigned to the ICMPv6 protocol, in which case it is an IP packet, and a tunnel identifier should be inserted.

Once the identifier Tunnel-ID is thus inserted, the frame TRAM_E is transmitted by the source proxy PR-S to the destination proxy PR-D. This is the subject of a step E290 of the general method, as illustrated in FIG. 5.

The general method then includes a step E300 of receiving, from the source proxy PR-S, the frame TRAM_E by the destination proxy PR-D.

Upon receipt of said frame TRAM_E, the destination proxy PR-D verifies, during a step E310 of the general method, whether the identifier Tunnel-ID, inserted between said hardware addresses CE-S MAC@, CE-D MAC@ and the IP packet, corresponds to an identifier, called “second identifier”, contained in a data table stored by said destination proxy PR-D and matching the hardware address CE-D MAC@ of the destination host CE-D with said second identifier.

Finally, if the verification of the match between the tunnel identifier Tunnel-ID and said second identifier is positive, the destination proxy PR-D removes the identifier Tunnel-ID from the frame TRAM_E during a step E320.

Furthermore, following the removal of the identifier Tunnel-ID, the destination proxy PR-D transmits the frame TRAM_E to the destination host CE-D during a step E330.

The destination IP address attached to this IP packet is denoted VPN_IP-D@ in FIG. 5.

The general method, and therefore particularly the first, second and third methods, have been described so far considering that the computer system SI includes said first and second servers SERV-1, SERV-2. That being said, nothing excludes envisaging that the computer system SI includes only a single server comprising a proxy and a host, these therefore being able to bear the denomination “source” or “destination” depending on whether said host is intended to be the originator or recipient of a communication. Consequently, in this configuration, said set of steps E10 to E180 is executed only once, namely therefore for the host considered in said single server. It is also noted that there is no need to envisage step E190 as long as no other host is considered in the computer system SI.

FIG. 6 schematically represents the Ethernet frame TRAM_E after the source proxy PR-S has introduced the tunnel identifier Tunnel-ID when implementing the method of FIG. 5.

As can be seen in this FIG. 6, said identifier Tunnel-ID is placed between the hardware addresses CE-S MAC@, CE-D MAC@ and the IP packet (here contained in an IP frame).

It is noted that the Ethernet frame TRAM_E can optionally include one or more VLAN identifiers S-VLAN or C-VLAN known to those skilled in the art, either being able to serve as an identifier for the Ethernet switches to which the computer servers SERV-1 and SERV-2 are connected, to recognize, among others, the frames to be switched within the VLAN virtual local area switching network to which the proxies PR-S and PR-D are connected.

The rest of the description now relates to one variant of embodiment of the computer system SI as well as methods implemented by the entities belonging to this variant of embodiment and making it possible to establish communications from the private VPN network (respectively towards the private VPN network) from a host to another IP/MPLS VPN network located outside the data center DC (respectively from another IP/MPLS VPN network located outside the data center DC).

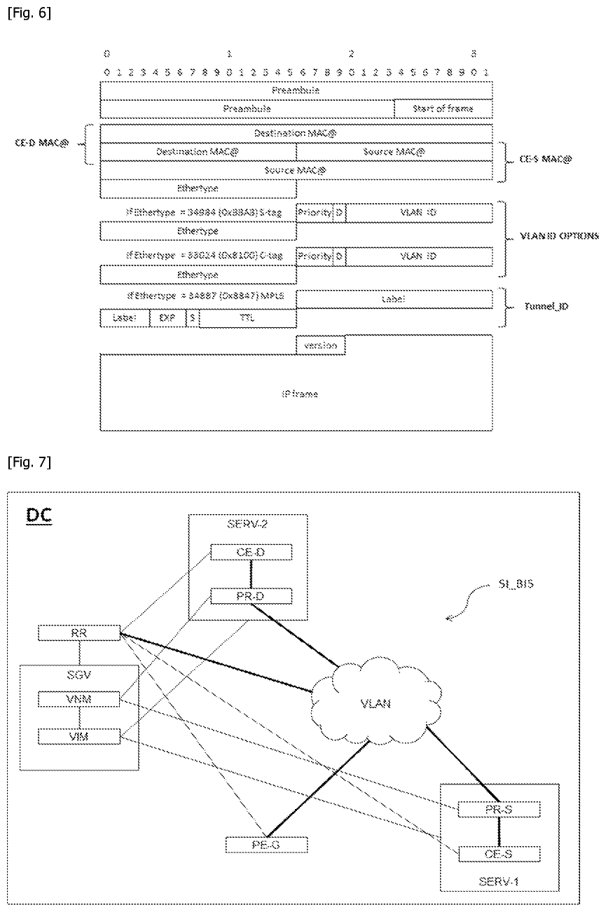

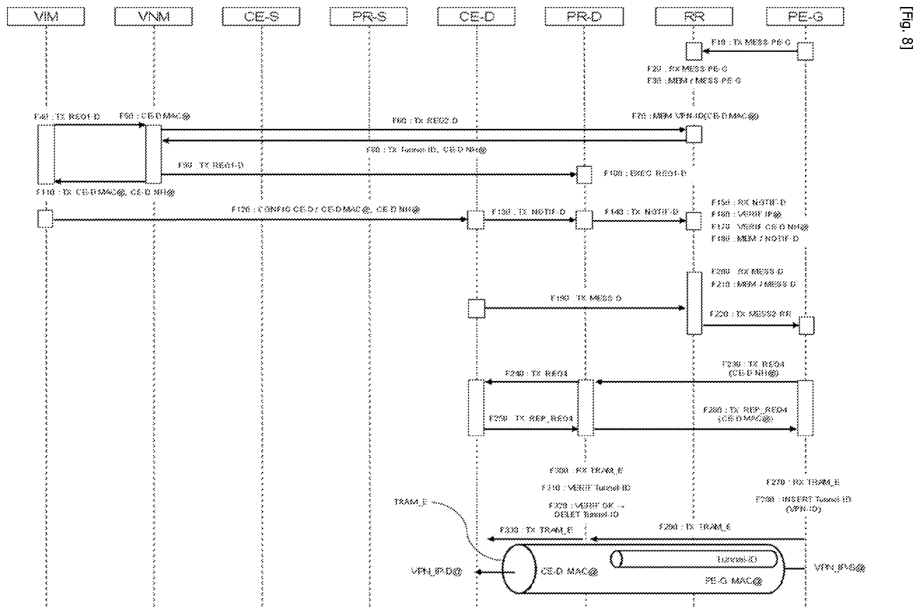

FIG. 7 schematically represents, in its environment, another particular embodiment of a computer system SI_BIS according to the invention.

The computer system SI_BIS of FIG. 7 differs from the computer system of FIG. 1 in that it additionally includes a network gateway PE-G connected to the VLAN local area network. Such a gateway PE-G is, in a manner known per se, positioned at the periphery of the VLAN local area network implemented in the data center DC by the computer system SI_BIS. It is noted that the gateway PE-G is also associated with a hardware address PE-G MAC@.

The computer system SI_BIS is configured to implement particular implementations of the general method which differ from the one described above with reference to FIG. 5.

FIG. 8 represents, in the form of a flowchart, one particular implementation, called “incoming communication implementation”, of the general method implemented by the computer system SI_BIS of FIG. 7. Said incoming communication implementation makes it possible to establish a communication from a network external to the data center DC to the destination host CE-D.

As illustrated in FIG. 8, said general method initially includes a step F10 of transmitting, from the gateway PE-G to the route reflector RR, an advertisement message MESS-PE-G including the tunnel identifier Tunnel-ID as well as the routes accessible, by means of said tunnel identifier Tunnel-ID and in the private VPN network identified by the identifier VPN-ID, via an IP address PE-G NH@ of said gateway PE-G.

Said advertisement message MESS-PE-G is received by the route reflector RR during a step F20 of the general method. More particularly, said step F20 is implemented by a receiving module equipping the route reflector RR and dedicated to this purpose.

The route reflector RR then saves, during a step F30 of the general method, the routes thus advertised in association with the identifier VPN-ID, said tunnel identifier Tunnel-ID and the address PE-G NH@ of the gateway PE-G. More particularly, said step F30 is implemented by a saving module equipping the route reflector RR and dedicated to this purpose.

In said incoming communication implementation, the general method also includes steps F40 to F210 which are respectively identical to steps E10 to E180 described above for the destination host CE-D with reference to FIG. 5.

Then, in said incoming communication implementation, the general method also includes a step F220 of transmitting, from the route reflector RR to the gateway PE-G, an advertisement message MESS2-RR including the routes accessible, by means of said tunnel identifier Tunnel-ID and in the private VPN network identified by said identifier VPN-ID, via the hop address CE-D NH@. More particularly, said step F220 is implemented by a transmission module equipping the route reflector RR and dedicated to this purpose.

It is therefore noted that the message MESS2-RR differs from the message MESS-PE-G in that the message MESS-PE-G advertises to the route reflector RR the routes accessible via the gateway PE-G (via PE-G NH@), where MESS2-RR advertises to the gateway PE-G the routes accessible via the destination host CE-D (via CE-D NH@).

Said general method also includes a step F230 of transmitting, from the gateway PE-G to the destination proxy PR-D, a request REQ4. Said request REQ4 is an address resolution request for the hop address CE-D NH@.

Upon receipt of the request REQ4, the destination proxy PR-D transmits said request REQ4 to the destination host CE-D during a step F240 of the general method.

On receipt of the request REQ4, the destination host CE-D responds to said request REQ4 by transmitting, during a step F250 of the general method, a response REP_REQ4 to the destination proxy PR-D, said response including the hardware address CE-D MAC@.

Upon receipt of said response REP_REQ4, the destination proxy PR-D transmits said response REP_REQ4 to the gateway PE-G during a step F260 of the general method.

Furthermore, in the incoming communication implementation illustrated by FIG. 8, the general method also includes a step F270 of receiving, by the gateway PE-G and from a network external to the data center, an IP packet intended for the destination host CE-D.

The source IP address attached to this IP packet is again denoted VPN_IP-S@ in FIG. 8.

Upon receipt of the IP packet, the gateway PE-G inserts said IP packet, during a step F280 of the general method, in a frame TRAM_E including the hardware addresses PE-G MAC@ and CE-D MAC@ as well as the tunnel identifier Tunnel-ID between the hardware addresses PE-G MAC@, CE-D MAC@ and the IP packet.

Once the IP packet and the identifier Tunnel-ID are thus inserted, the frame TRAM_E is transmitted by the gateway PE-G to the destination proxy PR-D. This is the subject of a step F290 of the general method according to said incoming communication implementation, as illustrated in FIG. 8.

The general method then includes a step F300 of receiving, from the gateway PE-G, the frame TRAM_E by the destination proxy PR-D.

Upon receipt of said frame TRAM_E, the destination proxy PR-D verifies, during a step F310, whether the identifier Tunnel-ID, inserted between said hardware addresses PE-G MAC@, CE-D MAC@ and the IP packet corresponds to the tunnel identifier of which it is aware matched with the hardware address CE-D MAC@ of the destination host CE-D.

Finally, if the match verification is positive, the destination proxy PR-D removes the identifier Tunnel-ID from the frame TRAM_E during a step F320.

In addition, following the removal of the identifier Tunnel-ID, the destination proxy PR-D transmits the frame TRAM_E to the destination host CE-D during a step F330.

The destination IP address attached to this IP packet is again denoted VPN_IP-D@ in FIG. 8.

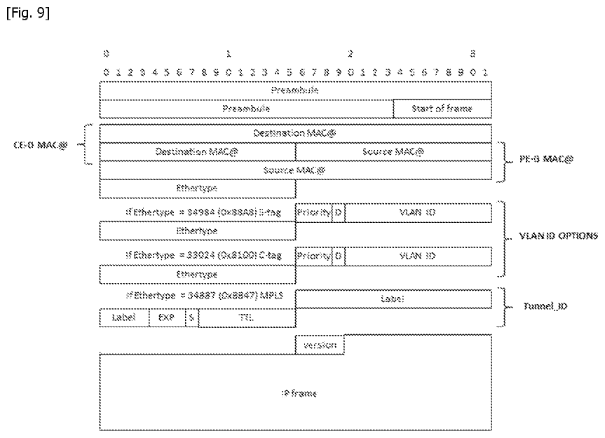

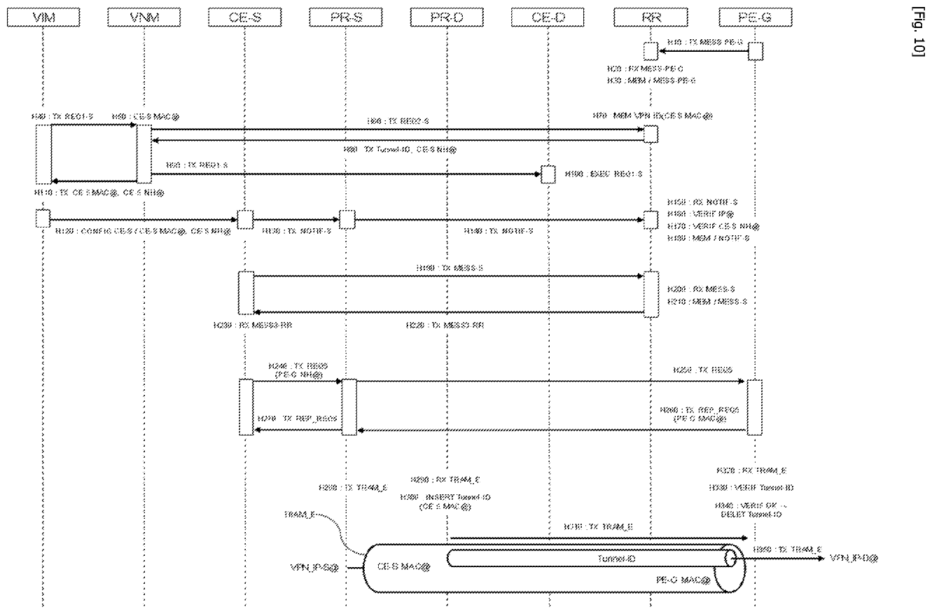

FIG. 9 schematically represents the Ethernet frame TRAM_E after the gateway PE-G has introduced the tunnel identifier Tunnel-ID when implementing the method of FIG. 8.

FIG. 10 represents, in the form of a flowchart, a particular implementation, called “outgoing communication implementation”, of the general method implemented by the computer system SI_BIS of FIG. 7. Said outgoing communication implementation makes it possible to establish a communication from the source host CE-S to a network external to the data center DC.

As illustrated in FIG. 10, said general method initially includes steps H10 to H30 which are respectively identical to steps F10 to F30 described above with reference to FIG. 8.

In said outgoing communication implementation, the general method also includes steps H40 to H210 which are respectively identical to steps E10 to E180 described above for the destination host CE-S with reference to FIG. 5.

Then, in said outgoing communication implementation, the general method also includes a step H220 of transmitting, from the route reflector RR to the source host CE-S, an advertisement message MESS3-RR including the routes accessible, in the private VPN network, via the IP address PE-G NH@ of said gateway PE-G. More particularly, said step H220 is implemented by a transmission module equipping the road reflector RR and dedicated to this purpose.

It is noted that the difference between the messages MESS-PE-G and MESS3-RR lies in the fact that the routes accessible via the gateway PE-G (via PE-G NH@) are on the one hand advertised to the route reflector RR (via the message MESS-PE-G) by the gateway PE-G, then on the other hand advertised to the source host CE-S (via the message MESS3-RR) by the route reflector RR.

Said advertisement message MESS3-RR is received by the source host CE-S during a step H230 of the general method according to said outgoing communication implementation. More particularly, said step H230 is implemented by a receiving module equipping the source host CE-S and dedicated to this purpose.

Said general method also includes a step H240 of transmitting, from the source host CE-S to the source proxy PR-S, a request REQ5. Said request REQ5 is an address resolution request for the IP address PE-G NH@ of the gateway PE-G.

Upon receipt of the request REQ5, the source proxy PR-S transmits said request REQ5 to the gateway PE-G during a step H250 of the general method.

Upon receipt of the request REQ5, the gateway PE-G responds to said request REQ5 by transmitting, during a step H260 of the general method, a response REP_REQ5 to the source proxy PR-S, said response including the hardware address PE-G MAC@.

Upon receipt of said response REP_REQ5, the source proxy PR-S transmits said response REP_REQ5 to the source host CE-S during a step H270 of the general method.

Furthermore, in the outgoing communication illustrated by FIG. 10, the general method also includes a step H280 of transmitting, by the source host CE-S and to the gateway PE-G, an Ethernet frame TRAM_E encapsulating an IP packet. Said Ethernet frame TRAM_E here includes the hardware addresses CE-S MAC@ and PE-G MAC@.

The source IP address attached to this IP packet is again denoted VPN_IP-S@ in FIG. 10.

The general method then includes a step H290 of receiving, from the source host CE-S, the frame TRAM_E by the source proxy PR-S.

Upon receipt of the frame TRAM_E, the source proxy PR-S inserts into said frame TRAM_E, and during a step H300 of the general method, the tunnel identifier Tunnel-ID between the hardware addresses CE-D MAC@, PE-G MAC@ and the IP packet.

Once the identifier Tunnel-ID is thus inserted, the frame TRAM_E is transmitted by the source proxy PR-S to the gateway PE-G. This is the subject of a step H310 of the general method according to said outgoing communication implementation, as illustrated in FIG. 10.

The general method then includes a step H320 of receiving, coming from the source proxy PR-S, the frame TRAM_E by the gateway PE-G.

Upon receipt of said frame TRAM_E, the gateway PE-G verifies, during a step H330, whether the identifier Tunnel-ID, inserted between said hardware addresses CE-S MAC@, PE-G MAC@ and the IP packet, corresponds to the tunnel identifier of which it is aware (i.e. the tunnel identifier communicated to the route reflector during step H10) matched with the identifier VPN-ID of the private VPN network.

Finally, if the match verification is positive, the gateway PE-G retrieves the IP packet from the frame TRAM_E during a step H340.

Furthermore, following the retrieval of the IP packet, the gateway PE-G propagates the IP packet outside the VLAN local area network to an appropriate remote host in the private VPN network during a step H350.

The destination IP address attached to this IP packet is again noted VPN_IP-D@ in FIG. 10.

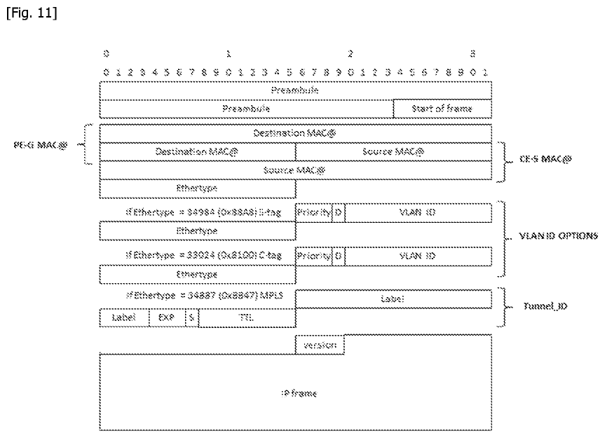

FIG. 11 schematically represents the Ethernet frame TRAM_E after the source proxy PR-S has introduced the tunnel identifier Tunnel-ID when implementing the method of FIG. 10.

1. A communication method implemented by a route reflector belonging to a computer system implementing a virtual local area switching network to which said route reflector is connected, said computer system further including at least one server in which a multiprotocol label switching virtual proxy and a host are connected, said virtual proxy being connected to the local area network as well as attached to a virtual private communication network, said method including, for the host of each server, a set of steps of:
saving an identifier of said private network in association with a hardware address of the host,
receiving, from the virtual proxy connected to said host, a notification including a hop IP address of the host associated with said hardware address,
upon a determination that, before receipt of said notification, one or more other IP addresses have been saved in association with one or more hardware addresses of the hosts by the route reflector, verifying a match between said hop IP address and said one or more other IP addresses,
upon a determination that the verification of the match between said hop IP address and said one or more other IP addresses is negative, or upon a determination that no other IP address has been saved by the route reflector before the receipt of said notification, saving said hop IP address in association with the hardware address of the host,
receiving, from the host, an advertisement message including any routes accessible via said hop IP address, and
saving said advertised routes in association with the identifier of said private network, the hardware address of the host and said hop IP address.

2. The method according to of claim 1, wherein the computer system includes a server in which a virtual destination proxy, and a destination host are connected, as well as a gateway connected to the local area network, said method further comprising, before the execution of said set of steps, steps of:
receiving, from said gateway, an advertisement message including a tunnel identifier, as well as any routes accessible, by means of said tunnel identifier and in the private network, via an IP address of said gateway, and
saving said advertised routes in association with the identifier of said private network, said tunnel identifier, and said IP address of the gateway,
said set of steps associated with the destination host also including steps of:
transmitting the tunnel identifier to a virtualization management system belonging to the computer system, and
transmitting to said gateway an advertisement message including any routes accessible, by means of said tunnel identifier and in the private network, via said hop IP address.

3. The method of claim 1, wherein the computer system includes a server in which a virtual source proxy and a source host are connected, as well as a gateway connected to the local area network, said method further including, before the execution of said set of steps, steps of:
receiving, from said gateway, an advertisement message including a tunnel identifier, as well as any routes accessible, by means of said tunnel identifier and in the private network, via an IP address of said gateway, and
saving said advertised routes in association with the identifier of said private network, said tunnel identifier, and said IP address of the gateway,
said set of steps associated with the source host also including steps of:
transmitting the tunnel identifier to a virtualization management system belonging to the computer system,
transmitting to the source host an advertisement message including any routes accessible, in the private network, via the IP address of the gateway.

4. The method of claim 1, wherein the computer system includes a first server in which a virtual source proxy and a source host are connected, as well as a second server in which a virtual destination proxy called and a destination host are connected, said source and destination proxies being attached to the same virtual private communication network, said method including an execution of said set of steps for each of the hosts of said servers and, after said set of steps has been executed for the destination host, a step of transmitting to the source host an advertisement message including any routes accessible via the hop IP address of the destination host.

5. A communication method implemented by a host belonging to a computer system implementing a virtual local area switching network, said computer system further including a route reflector connected to said local area network, and a server in which a multiprotocol label switching virtual proxy and said host are connected, said virtual proxy being connected to the local area network as well attached to a virtual private communication network, said method including steps of:
freely transmitting to the virtual proxy a notification including a hardware address of the host as well as a hop IP address of the host associated with said hardware address,
transmitting to the route reflector an advertisement message including any routes accessible via said hop IP address.

6. The method of claim 5, wherein the computer system includes a server in which a virtual source proxy and a source host are connected, as well as a gateway connected to the local area network, said method being implemented by said source host and further including a step of receiving, from the route reflector, an advertisement message including any routes accessible, in the private network, via the IP address of the gateway.

7. The method of claim 5, wherein the computer system includes a first server in which a virtual source proxy and a source host are connected, as well as a second server in which a virtual destination proxy and a destination host are connected, said source and destination proxies being attached to the same virtual private communication network, said method being implemented by said source host and including a step of receiving, from the route reflector, an advertisement message including any routes accessible via the hop IP address of the destination host.

8. A non-transitory computer readable storage medium having stored thereon instructions which, when executed by a processor, cause the processor to implement the method of claim 1.

9. A non-transitory computer-readable recording medium having stored thereon instructions which, when executed by a processor, cause the processor to implement the method of claim 5.

10. A route reflector belonging to a computer system implementing a virtual local area switching network to which said route reflector is connected, said computer system further including at least one server in which a multiprotocol label switching virtual proxy and a host are connected, said virtual proxy being connected to the local area network as well as attached to a virtual private communication network, said method including, for the host of each server, the route reflector configured to:
save an identifier of said private network in association with a hardware address of the host,
receive, from the virtual proxy connected to said host, a notification including a hop IP address of the host associated with said hardware address,
upon a determination that, before receipt of said notification, one or more other IP addresses have been saved in association with one or more hardware addresses of the hosts by the route reflector, verify a match between said hop IP address and said one or more other IP addresses,
upon a determination that the verification of the match between said hop IP address and said one or more other IP addresses is negative, or upon a determination that no other IP address has been saved by the route reflector before the receipt of said notification, save said hop IP address in association with the hardware address of the host,
receive, from the host, an advertisement message including any routes accessible via said hop IP address, and
save said advertised routes in association with the identifier of said private network, the hardware address of the host, and said hop IP address.

11. A host belonging to a computer system implementing a virtual local area switching network, said computer system further including a route reflector connected to said local area network, and a server in which a multiprotocol label switching virtual proxy and said host are connected, said virtual proxy being connected to the local area network as well attached to a virtual private communication network, said host being configured to:
freely transmit to the virtual proxy a notification including a hardware address of the host as well as a hop IP address of the host associated with said hardware address,
transmit to the route reflector an advertisement message including any routes accessible via said hop IP address.

12. A computer system including:
the route reflector claim 10; and
at least one server in which a multiprotocol label switching virtual proxy and a host are connected, the host being configured to:
freely transmit to the virtual proxy a notification including a hardware address of the host as well as the hop IP address of the host associated with said hardware address,
transmitting to the route reflector the advertisement message including any routes accessible via said hop IP address.
